(19) United States
(12) Patent Application Publication
(10) Pub. No.: US 2011/0168959 A1
(43) Pub. Date: Jul. 14, 2011

(54) METHOD AND APPARATUS FOR EXTRACTING OF CABLE ELEMENTS

(76) Inventor: Alois Pichler, Ybbsitz (AT)

(21) Appl. No.: 13/062,422

(22) PCT Filed: Sep. 7, 2009
(86) PCT No.: PCT/AT2009/000350

§ 371 Date: Mar. 4, 2011

(30) Foreign Application Priority Data
Sep. 8, 2008 (AT) A 1390/2008

(51) Int. Cl. H02G 1/08

(52) U.S. Cl. 254/134.3 R

(57) ABSTRACT

The invention relates to a method and to an apparatus (10) for extracting cable elements (5) from cable pipes (2) in cable ducts (1), with a clamping apparatus (13) for clamping the cable element (5) and an apparatus (8) for applying a tensile force (F) onto the cable element (5) for extracting the cable element (5) from the cable pipe (2). For simple and fast extraction of a cable element (5) from a cable pipe (2) in a cable duct (1), the clamping apparatus (13) is arranged on a skid (12), which skid (12) is arranged essentially in the longitudinal direction of the cable element (5) so as to move in a translational manner on a base part (11) and in that the apparatus (8) for applying a tensile force (F) onto the cable element (5) via at least one drive unit (16) arranged between the base part (11) and the skid (12) is provided for achieving the translational movement of the skid (12) with respect to the base part (11), and in that the base part (11) is designed to be braced against a wall (15) of the cable shaft (1) surrounding the cable pipe (2).

The invention relates to a method for extracting cable elements from cable pipes in cable ducts, said cable element being clamped by a clamping apparatus and a tensile force being applied onto the cable element, extracting the cable element from the cable pipe, with the cable element being clamped within the cable duct and being extracted from the cable pipe step by step by extracting a section of the cable element from the cable pipe, substantially in the longitudinal direction of the cable element after clamping it with the clamping apparatus, before opening the clamping apparatus and moving it back by the section in the direction of the cable pipe, clamping the cable element again and extracting the section.

The present invention further relates to an apparatus for extracting cable elements from cable pipes in cable ducts, with a clamping apparatus for clamping the cable element and an apparatus for the application of a tensile force onto the cable element for extracting the cable element from the cable pipe.

A technique for installing fibre optic cables is known from US 2007/0048090 A1. Therein, a pilot hole is excavated between an entrance pit and an exit pit with the aid of a mole before a flexible strand is drawn through the pilot hole. At the end of the exit pit the strand is connected to the duct bundle to be drawn in by a connecting member. A machine for cyclic pulling of the strand is placed in the entrance pit. The pulling machine comprises a frame with a plate which abuts the entrance of the pilot hole. In order to apply a tensile force onto the strand, two hydraulically operable cylinders are provided, at the ends of which a clamping device for the strand is provided. The strand and the cable bundle connected thereto are pulled through the pilot hole over a plurality of actuation cycles of the cylinders step by step, by repeatedly clamping the strand, thrusting the cylinder rods forward so as to extract a certain section of the strand, and releasing the clamping device, and retracting the rods.

The term “cable element” covers entire cables as those usually laid within cable pipes as well as parts of cables such as single stranded wires or bundles of a cable's stranded wires.

The present invention relates mainly to cables known as pipe cables, which are particularly used for telecommunication, power supply, television etc. and are usually installed within a pipe made of plastic or concrete. In most cases, only one cable, having a diameter of 100 mm, for example, is installed per cable pipe. However, it is possible to install multiple cables or other lines within such cable pipes. Pipe cables are often provided with a water-repellent medium, in particular tar, on their outsides to prevent humidity from leaking into the inside of the cable. Both the water-repellent medium and the casing of the cable, which may be made of plastic or lead, usually adhere to the inside of the cable pipe, so extracting such cables is made more difficult. This adhesive effect is increased by frictional heat that is generated during the drawing-in of such cables, leading to a softening of the water-repellent medium as well as the casing of the cable and the creation of a bonding with the inside of the cable pipe. Heat may also be generated in already laid cables by current flowing through the stranded wires of the cable. Dirt in the cable pipe is another factor leading to a bonding between the cable pipe and the cable, making extraction of the cable more difficult.

As a result, relatively strong tensile forces that are capable of breaking the bonding between the cable and the cable pipe and pulling the weight of the cable have to be applied onto the cable in order to extract cables from cable pipes in cable ducts. As the cable ducts which provide access to the cable pipes are relatively small in most cases, the devices for extracting the cable from the cable pipe are often arranged outside of the ducts. This requires the arrangement of corresponding deflection rollers which guide the cable to be extracted from the end of the cable pipe to the apparatus for applying a tensile force onto the cable, such as a corresponding cable winch. At every deflection roller a considerable part of the tensile force, which has to be received by it, is lost. If multiple deflection rollers are arranged, only a fraction of the tensile force applied by the cable winch will be available for extracting the cable from the cable pipe in the end. To be able to loosen the cables that often adhere to the cable pipes, however, the cable winch must be able to provide a correspondingly strong tensile force. Accordingly, not only the cable winch but also the deflection rollers have to be designed sufficiently voluminous and heavy, thus making the extraction process particularly difficult as well as time- and cost-intensive.

To improve this process, apparatuses for applying the tensile force have already been arranged within the duct in order to be able to omit the deflection rollers for guiding the cable to the cable winch or at least reduce their number. Winches such as squeezing winches, which are used for continuously extracting the cable from the cable pipe, however, are relatively heavy and voluminous as well, so handling them within a cable duct is relatively labour-intensive.

The object of the present invention, hence, is to create a method for extracting cable elements from cable pipes in cable ducts as mentioned above, which can be carried out as easily, fast and cost-efficiently as possible while avoiding or at least reducing the disadvantages of known methods.

A further object is to create an apparatus for extracting cable elements from cable pipes in cable ducts as mentioned above, which can be manufactured as small, lightweight and cost-efficient as possible while allowing easy and swift use in a cable duct. The apparatus should be capable of applying a correspondingly strong tensile force onto the cable element, so that the cable element can be released from the cable pipe and a fast extracting of the cable element from the cable pipe is ensured.

The object according to the invention is achieved by a method as mentioned above, in which the clamping apparatus is moved along the sections on a skid in a translational manner. By extracting the cable element from the cable pipe step by step, the method can be carried out directly within the cable duct as well. Since the tensile force is applied onto the cable element substantially in the longitudinal direction of the cable element, essentially the full tensile force can act on the cable. The method according to the invention is applied, in particular, when the cables and/or cable elements adhere to the cable pipe. After loosening the cable element in the cable pipe, conventional methods for extracting the cable elements may be used as well.

Preferably the cable element extracted from the cable pipe is guided out of the cable duct and rolled up. Guiding the cable element out of the cable duct can be done by corresponding deflection rollers that are known per se or the like. The rolled-up extracted cable element can then be recycled, especially for recycling the copper of the stranded copper wires that are usually contained within the cable.

Alternatively, instead of rolling up the extracted cable element or also in combination with the rolling-up, the cable element extracted from the cable pipe may be cut as well. This way, cable pieces of a desired length, which are easier to carry off, can be produced. This method is particularly useful, for example, on roads with heavy traffic where it is not possible to redirect traffic around the duct for arranging a winch and a reel.

In order to loosen the cable element within the cable pipe, a corresponding solvent may be introduced before the extraction process. As has already been mentioned above, cables are often covered by layers of tar. These can be softened by using fatty acid methyl ester (biodiesel), for instance.

The solvent can be fed into the cable pipe in a very easy and fast way by atomizing it and blowing it into the cable pipe. Conventional compressors can be used for blowing it in.

As has already been mentioned above, the incremental extracting from the cable pipe according to the invention enables a continuous extraction of the cable element from the cable pipe after the cable element has been loosened within the cable pipe. By applying a continuous extraction method that is known per se and can be carried out, for example, by using a corresponding squeezing winch, a faster extraction process is possible in most cases.

The cable element is preferably clamped hydraulically. Corresponding hydraulic cylinders can apply a sufficiently strong clamping force onto the cable element. When extracting entire cables, it is advisable to apply a particularly strong clamping force, for example in the range of several tons, so that the casing of the cable is firmly bonded to the inside of the cable, thus preventing a relative movement between individual cable elements during the extraction process.

The object according to the invention is also achieved by an apparatus for extracting cable elements from cable pipes in cable ducts mentioned above, wherein the clamping apparatus is arranged on a skid, which skid is arranged essentially in the longitudinal direction of the cable element so as to move in a translational manner on a base part and the apparatus is provided for application of a tensile force onto the cable element by at least one drive unit arranged between the base part and the skid to achieve the translational movement of the skid with respect to the base part, and the base part is designed to be braced against a wall of the cable duct surrounding the cable pipe. Such design of an apparatus for extracting cable elements facilitates a small and lightweight construction which can be introduced into a cable duct and used there in an easy and swift manner. Here, it is substantial for the apparatus and/or its base part to be braced against a wall surrounding the cable pipe, so that the tensile force applied onto the cable element is substantially fully available for the extraction process. The respective counteracting force of the tensile force will be transferred to the wall of the cable duct without putting pressure on supporting constructions or the like. Thus, respective supporting constructions that make handling of the apparatus more complicated may usually be omitted.

Preferably, the clamping apparatus is connected to the skid in a releasable manner. By this releasable connection the apparatus can be separated, making its introduction into the cable duct easier. Preferably, the releasable connection between clamping apparatus and skid enables connecting and separating it without using tools. In addition, a suitable construction makes it possible to arrange the clamping apparatus on the skid in a number of different ways, depending on the space available in the cable duct. The clamping apparatus may, in particular, be arranged on the skid in order to carry out the clamping of the cable element within the skid, or be arranged in front of the skid in the direction of the pull, so that the clamping of the cable element is achieved outside of the skid.

For the base part to be braced against the wall of the cable duct surrounding the cable pipe, preferably a respective adapter for arrangement at the end of the cable pipe is provided. The adapter projects partially into the cable pipe with the cable element to be extracted. For fixing the apparatus within the cable pipe of the cable element to be extracted, corresponding wedges or the like may be arranged between the adapter and the inner wall of the cable pipe.

Preferably, the adapter is formed rotationally symmetrically, and it usually is designed in accordance with the cable pipe. As cable pipes are usually circular, the adapter will preferably be of cylindrical or partially cylindrical shape. This ensures that the entire apparatus may be rotated around 360° with respect to the cable pipe and placed in a desired position depending on the space available.

Preferably, the clamping apparatus comprises at least one hydraulic cylinder. The hydraulic cylinder(s) are connected to a corresponding hydraulic power unit or a manual pump. Theoretically, other clamping apparatuses such as mechanical ones are possible as well, but these require more maintenance and more time for the clamping process.

In order to achieve an optimal clamping of the cable element and prevent slipping of the same, the clamping apparatus comprises two clamping plates that preferably have a profile. These clamping plates with their profiles are designed, for example, corrugated or geared and are pressed into the cable element to be extracted in order to prevent slipping of the same, so the entire tensile force can act on the cable element. Instead of using planar clamping plates, suitably shaped clamping plates may be used as well, such as a U-shaped lower clamping profile, into which the cable or cable element to be extracted is placed, and an upper clamping plate, which is positioned between the arms of the U-shaped profile.

The drive unit for achieving a translational movement of the skid with respect to the base part is preferably also formed by at least one hydraulic cylinder. As has already been mentioned above, the hydraulic cylinders are connected to a corresponding hydraulic power unit or a manual pump. In order to achieve an arrangement of the drive unit that is symmetrical on both sides of the cable element to be extracted, it is best to arrange two hydraulic cylinders on both sides of the cable element to be extracted. Such hydraulic cylinders can provide great force while being small constructions at the same time.

For easy handling of the extraction apparatus, the hydraulic cylinders are connected to respective operating elements. In the simplest case there are two operating elements, with one operating element being connected to the hydraulic cylinders of the clamping apparatus and controlling the clamping of the cable element accordingly while the other operating element is connected to the hydraulic cylinders of the drive unit in order to achieve the translational movement of the skid and control the reciprocating motion of the skid with respect to the base part. The operating may be manual as well as automatic or semiautomatic.

The base part is preferably formed by two parallel tracks, between which the cable element to be extracted from the cable pipe can be arranged. This construction can be produced in a simple manner and exhibits a corresponding rigidity due to its symmetrical arrangement.

Preferably, a device for feeding a solvent into the cable pipe is provided, so that before and/or during the extraction process, the possibly present water-repellent medium on the outside of the cable element can be softened, thus facilitating the extraction process. As a solvent for tar, which is often used on the outside of the cable element, fatty acid methyl ester (bio-diesel) is especially effective. Moreover, biodiesel is relatively cheap and biodegradable, so contamination of the soil cannot happen.

For suitable bracing of the extraction apparatus in the cable duct, respective supporting elements or devices for the attachment of supporting elements may be provided on the base element. In their simplest form such devices may be formed by flaps or the like on the base element, between which corresponding rests or bolts towards walls in the cable duct may be arranged.

Once the cable element has been loosened from the cable pipe, a device for continuously extracting the cable element, which is connectable to the skid and enables a faster extraction procedure, may be used. Such a device for continuously extracting the cable element may be formed, for example, by a cable winch or squeezing winch.

A device for cutting off the cable element, which is possibly arranged on the skid as well and may be designed to be connectable to it, makes it possible to cut off the cable at desired spots in order to produce short pieces of cable that are easier to carry off, for example.

The present invention will now be discussed in more detail by means of the accompanying drawings. In the drawings

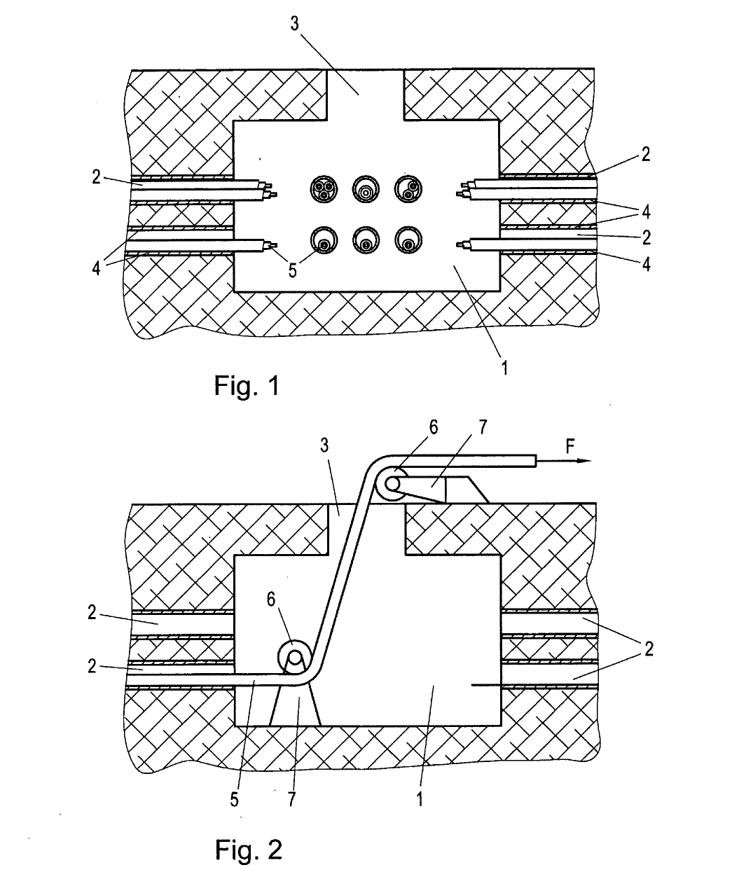

FIG. 1 shows a sectional view of a cable duct;

FIG. 2 shows the application of a conventional method for extracting a cable element from the cable pipe in a cable duct;

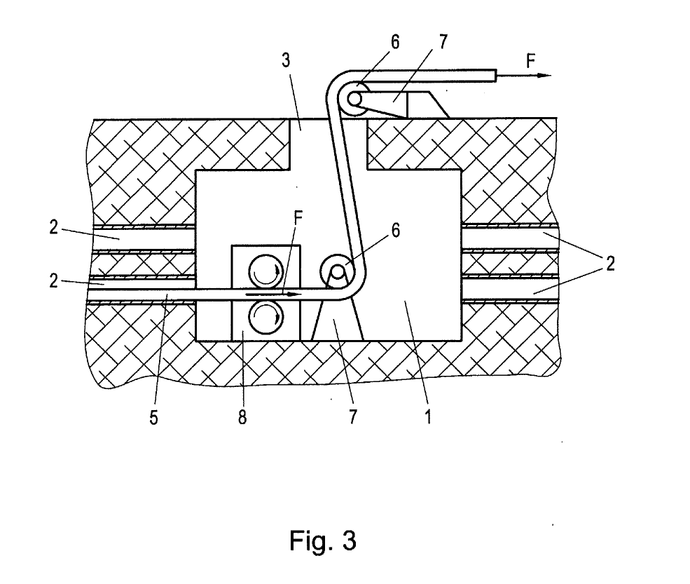

FIG. 3 shows an alternative method for extracting a cable element from the cable pipe in a cable duct according to the prior art;

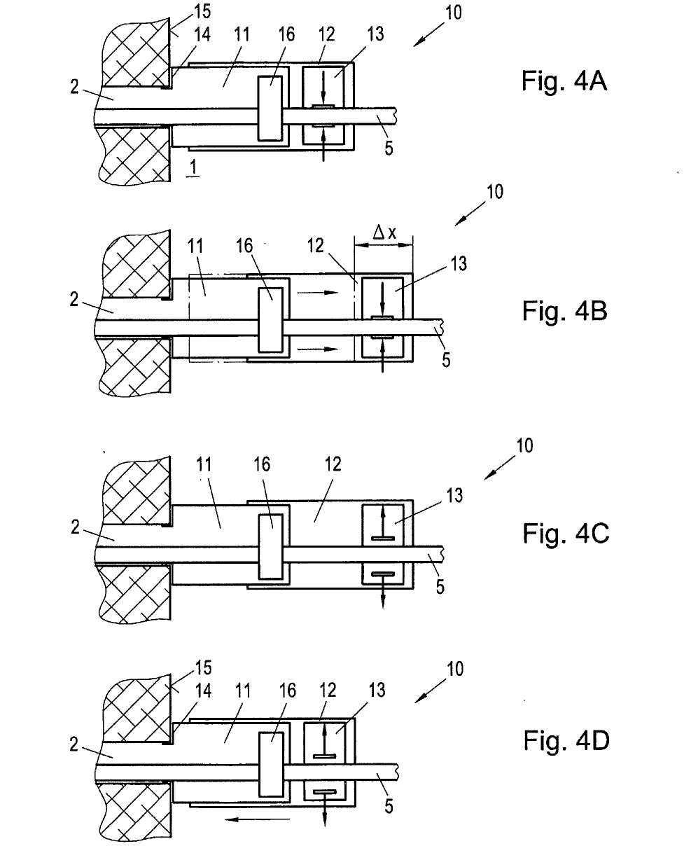

FIGS. 4A to 4D show the principle of a method for extracting a cable element from the cable pipe in a cable duct according to the invention;

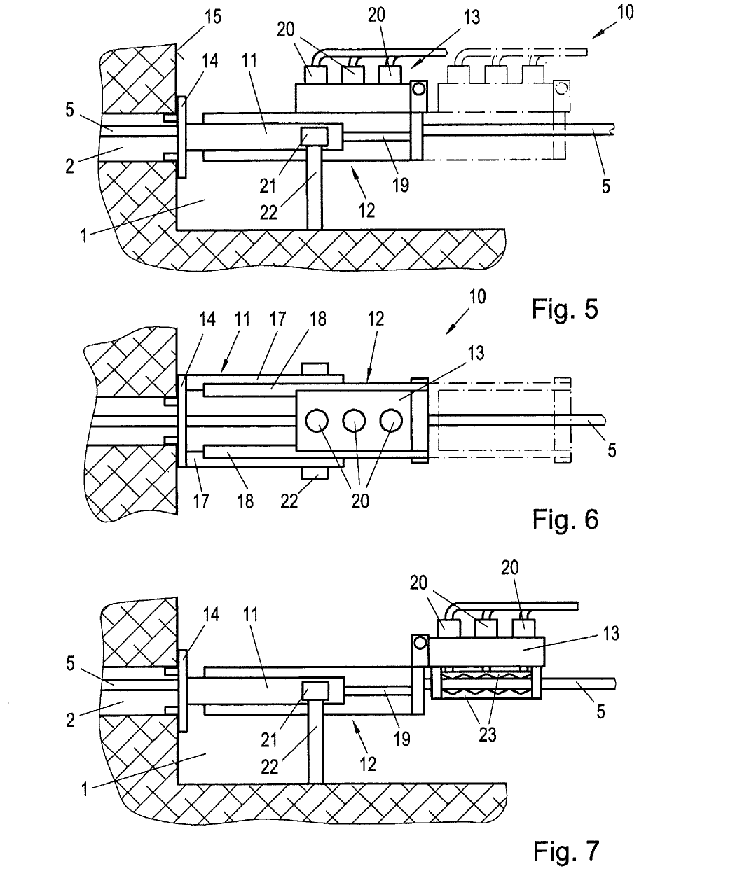

FIG. 5 shows a side view of an embodiment of an apparatus for extracting cable elements from cable pipes in cable ducts according to the invention;

FIG. 6 shows a plan view of the apparatus according to FIG. 5;

FIG. 7 shows an alternative embodiment of an apparatus for extracting cable elements from cable pipes in cable ducts according to the invention.

FIG. 1 shows a cable duct 1 in cross section, in which multiple cable pipes 2 come together. The cable duct 1 can be entered via a usually vertically arranged access path 3 that is closed by a respective cover (not shown). Multiple cable pipes 2, each comprising one or more cable elements 5, come together in the cable duct 1. A lining 4, made of plastic, for example, may be provided in the cable pipes 2. In the cable duct 1, the cables elements 5 are distributed and further installed in corresponding pipes for connecting them to individual homes, for example, or just connected to other cable elements. The cable elements 5 are usually covered by tar, plastic, in particular PVC, or other materials which adhere to the cable pipe 2 and/or the lining 4, possibly making the extracting process of such a cable element 5 more difficult. However, even with lead-coated cables or plastic cables, heat generation or other types of bonding may cause adhesion between the surface of the cable element 5 and the cable pipe 2 and/or the lining 4 during the extraction process. As a consequence, a relatively strong tensile force has to be applied in order to extract such a cable element 5.

FIG. 2 is a schematic representation of an extracting method according to the prior art, in which the cable element 5 is guided out of the cable duct 1 through the vertical access path 3 by deflection rollers 6, with a corresponding tensile force F being applied onto the cable element outside of the cable duct 1. The tensile force F can be generated by respective cable winches or the like (not shown). Due to the adhesion of the cable elements 5 inside the cable pipe 2 that has been mentioned above, a particularly strong tensile force F is usually required to act on the cable element 5 in order to extract it. Tensile forces of 3000-6000 kg or more are common, for example. The use of deflection rollers 6 for deflecting the cable element 5 from the cable duct 1 and guiding the same to the cable winch or the like (not shown) leads to considerable portions of the tensile force F being transferred without acting on the cable element 5. In order to receive these considerable portions of the tensile force F, the deflection rollers 6 and respective supporting members 7 have to exhibit appropriate strength. As a result, the deflection rollers 6 and the supporting members 7 are particularly heavy and voluminous, so placing them inside the cable duct 1 or outside the cable duct 1 requires great efforts.

FIG. 3 shows the principle of a further method of the prior art for extracting a cable element 5 from the cable pipe 2 in a cable duct 1, wherein an apparatus 8 for applying a tensile force F onto the cable element 5 is arranged within the cable duct 1. Such an apparatus 8 may be formed, for example, by a squeezing winch that is comprised of two rollers 9 between which the cable element 5 is clamped. Such an apparatus 8, which can also generate the usual tensile forces F for extracting a cable element 5 from a cable pipe 2, as well as suitable supporting members (not shown) are particularly voluminous and heavy, so handling them within the cable duct 1 is difficult as well.

FIGS. 4A to 4D show the principle of the method according to the invention and the apparatus according to the invention for extracting a cable element 5 from the cable pipe 2 in a cable duct 1. The apparatus 10 consists substantially of a base part 11 and a skid 12 with a clamping apparatus 13, which is arranged essentially in the longitudinal direction of the cable element 5 so as to move in a translational manner with respect to the base part 11. The base part 11 has an adapter 14 to be arranged on and abut the end of the cable pipe 2 with the cable element 5 to be extracted. Thereby, the base part 11 is arranged directly in front of the cable pipe 2 of the cable element 5 to be extracted and is braced against the wall 15, which surrounds the opening of the cable pipe 2, in a suitable manner. Due to the direct abutment of the base part 11 against the wall 15 in the cable duct 1, no intermediate elements, which would be stressed by a correspondingly strong force during the extraction process, are needed. As a result, the entire tensile force of, say, 2-6 t can be applied directly and safely onto the cable element 5 to be extracted. The method according to the invention and the apparatus according to the invention can provide a substantially improved safety during the extraction process as the tensile force is applied directly onto the cable element 5 and no tension occurs within the cable duct 1. As a consequence, the apparatus 10 according to the invention can be designed particularly small and lightweight, so placing it in the cable duct 1 can be done swiftly and easily. According to FIG. 4A, the cable element 5 is clamped by the clamping apparatus 13 and then, as can be seen in FIG. 4B, the skid 12 is translated by a section Δx in the longitudinal direction of the cable element 5 with respect to the base part 11. To translate the skid 12 with respect to the base part 11, a corresponding drive unit 16 is provided, which may be formed, for example, by hydraulic cylinders 19 (see FIGS. 5-7). Essentially, the entire force generated by the drive unit 16 acts on the cable element 5. The respective counteracting force is transferred into the wall 15 of the cable duct 1 via the adapter 14 of the base part 11. After translating the skid 12 together with the cable element 5 clamped therein, the clamping is released according to FIG. 4C before, according to FIG. 4D, the skid 12 is returned towards the cable pipe 2 by the section Δx. Afterwards, the clamping according to FIG. 4A is resumed. This way the cable element 5 is moved out of the cable pipe 2 step by step. After breaking the adhesion of the cable element 5 in the cable pipe 2 if applicable, the extraction process may be continued by a conventional continuous extraction method as well.

Moreover, it is possible to feed a solvent such as fatty acid methyl ester (biodiesel) into the cable pipe 2, either before or during the extraction process, for example by blowing it in by means of compressed air, which will soften any possible tar casing around the cable element 5, so that the extraction process can be facilitated.

FIGS. 5 and 6 show an embodiment of an apparatus 10 according to the invention for extracting a cable element 5 from a cable pipe 2 in a cable duct 1 in side view and plan view. The apparatus 10 comprises a base part 11 which is substantially formed by two parallel tracks 17. The base part 11 is provided with an adapter 14 or formed integrally with the latter, which projects partially into the cable pipe 2. Just as the usually circular-shaped cable pipe 2, the adapter 14 is rotationally symmetrical, so that the entire apparatus 10 for extracting the cable element 5 from the cable pipe 2 can be rotated around 360° with respect to the cable pipe 2. This is especially advantageous when there is little space in the cable duct 1 as the apparatus 10 can be arranged in a way that leaves sufficient space for clamping the cable element 5. Fixing the adapter 14 within the cable pipe 2 may be accomplished by corresponding wedges or the like, for example. The skid 12 is also formed by tracks 18, which are arranged on the tracks 17 of the base part 11 to be movable in a translational manner in the longitudinal direction of the cable element 5. The translational movement of the skid 12 with respect to the base part 11 is achieved by two hydraulic cylinders 19. The clamping apparatus 13 is releasably connected to the skid 12, with the illustrated embodiment having three hydraulic cylinders 20 for clamping the cable element 5. The hydraulic cylinders 19, 20 are connected to a corresponding hydraulic power unit or a manual pump (not shown). The base part 11 may comprise devices 21 for attaching supporting elements 22. After clamping the cable element 5 to the clamping apparatus 13 by the hydraulic cylinders 20, the skid 12 is moved in the longitudinal direction of the cable element 5 together with the clamping apparatus 13 by the hydraulic cylinders 19, which leads to the cable element 5 being extracted from the cable pipe 2. Next the clamping is released, as shown in FIGS. 4A-4D, and the skid 12 is returned, with the cable element 5 being extracted from the cable pipe 2 step by step after another clamping.

The preferred releasable connection of the clamping apparatus 13 to the skid 12 provides for an easy separation of the apparatus 10 and enables a fast and easy placing of the individual elements in the cable duct 1. In addition, it is possible to arrange the clamping apparatus 13 as illustrated in FIG. 7. In this case, the clamping apparatus 13 has been turned with respect to the embodiment in FIGS. 5 and 6 and placed in front of the skid 12 in the direction of the pull, i.e. outside of the skid 12, and has been connected to the same by suitable connecting elements. This way, it is easier to clamp the cable element 5 and extract it from the cable pipe 2 if there is little space next to it. As can further be seen in FIG. 7, the clamping apparatus 13 preferably has two clamping plates 23 with respective profiles between which the cable element 5 is packed.

FIGS. 5-7 show only one of many possible embodiments for carrying out the method according to the invention. By directly using the method and the apparatus within the cable duct 1 at the opening of the cable pipe 2 with the cable element 5 to be extracted, the apparatus 10 can be set up particularly fast and easily and be arranged and removed again from the cable duct 1 swiftly.

1. A method for extracting cable elements (5) from cable pipes (2) in cable ducts (1), wherein the cable element (5) is clamped by a clamping apparatus (13) and a tensile force (F) is applied onto the cable element (5) and the cable element (5) is extracted from the cable pipe (2), with the cable element (5) being clamped within the cable duct (1) and extracted from the cable pipe (2) step by step by pulling the cable element (5) out of the cable pipe (2) by a section (Δx), essentially in the longitudinal direction of the cable element (5) after clamping it by the clamping apparatus (13), then opening the clamping apparatus (13) and moving it back by the section (Δx) in the direction of the cable pipe (2), clamping the cable element (5) again and extracting it by the section (Δx), characterised in that the clamping apparatus (13) is moved by the sections (Δx) on a skid (12) in a translational manner.

2. The method according to claim 1, characterised in that the cable element (5) extracted from the cable pipe (2) is guided out of the cable duct (1) and rolled up.

3. The method according to claim 1, characterised in that the cable element (5) extracted from the cable pipe (2) is being cut off.

4. The method according to claim 1, characterised in that a solvent is fed into the cable pipe (2).

5. The method according to claim 4, characterised in that the solvent is atomized and blown into the cable pipe (2).

6. The method according to claim 1, characterised in that the cable element (5) is extracted continuously from the cable pipe (2) after being pulled out of the cable pipe (2) step by step.

7. The method according to claim 1, characterised in that the cable element (5) is being clamped hydraulically.

8. An apparatus (10) for extracting cable elements (5) from cable pipes (2) in cable ducts (1), with a clamping apparatus (13) for clamping the cable element (5) and an apparatus (8) for applying a tensile force (F) onto the cable element (5) for extracting the cable element (5) from the cable pipe (2), characterised in that the clamping apparatus (13) is arranged on a skid (12), which skid (12) is arranged essentially in the longitudinal direction of the cable element (5) so as to move in a translational manner on a base part (11) and in that the apparatus (8) for applying a tensile force (F) onto the cable element (5) via at least one drive unit (16) arranged between the base part (11) and the skid (12) is provided for achieving the translational movement of the skid (12) with respect to the base part (11), and in that the base part (11) is designed to be braced against a wall (15) of the cable shaft (1) surrounding the cable pipe (2).

9. The apparatus (10) according to claim 8, characterised in that the clamping apparatus (13) is releasably connected to the skid (12).

10. The apparatus (10) according to claim 8, characterised in that an adapter (14) to be arranged at the end of the cable pipe (2) is arranged on the base part (11).

11. The apparatus (10) according to claim 10, characterised in that the adapter (14) is designed rotationally symmetrically.

12. The apparatus (10) according to claim 8, characterised in that the clamping apparatus (13) comprises at least one hydraulic cylinder (20).

13. The apparatus (10) according to any one of claims 8 to 12, characterised in that the clamping apparatus (13) comprises two clamping plates (23) that preferably have profiles.

14. The apparatus (10) according to claim 8, characterised in that the drive unit (16) for achieving a translational movement of the skid (12) with respect to the base part (11) is formed by at least one, preferably two, hydraulic cylinders (19).

15. The apparatus (10) according to claim 12, characterised in that the hydraulic cylinders (19, 20) are connected to operating elements.

16. The apparatus (10) according to claim 8, characterised in that the base part (11) is formed by two parallel tracks (17) between which the cable element (5) to be extracted from the cable pipe (2) is arrangeable.

17. The apparatus (10) according to claim 8, characterised in that a device for feeding a solvent into the cable pipe (2) is provided.

18. The apparatus (10) according to claim 17, characterised in that the solvent is formed by fatty acid methyl ester.

19. The apparatus (10) according to claim 8, characterised in that on the base element (11) supporting elements (22) or devices (21) for the attachment of supporting elements (22) are provided.

20. The apparatus (10) according to claim 8, characterised in that an apparatus for continuously extracting the cable element (5), which is connectable to the skid (12), is provided.

21. The apparatus (10) according to claim 8, characterised in that a means for cutting off the cable element (5) is provided.
